(19) United States
(12) Patent Application Publication
(10) Pub. No.: US 2013/0132203 A1
(43) Pub. Date: May 23, 2013

(54) ADVERTISING SYSTEM COMBINED WITH SEARCH ENGINE SERVICE AND METHOD FOR IMPLEMENTING THE SAME

(71) Applicant: Bin-Yi Cheng, Taipei City (TW)

(72) Inventor: Bin-Yi Cheng, Taipei City (TW)

(73) Assignee: INSTITUTE FOR INFORMATION INDUSTRY, Taipei (TW)

(21) Appl. No.: 13/324,244

(22) Filed: Dec. 13, 2011

(30) Foreign Application Priority Data
Nov. 23, 2011 (TW) 100142880

(51) Int. Cl. G06Q 30/02; G06F 15/16; G06F 17/30

(52) U.S. Cl. 705/14.58; 705/14.66; 707/E17.108

(57) ABSTRACT

An advertising system combined with search engine services, comprising a client and a server, wherein the server comprises a server-side transceiver, receiving an emotion signal and a keyword from the client; a search engine, performing search functions according to the keyword and generating a search result; an emotion analyzer, analyzing the emotion signal and generating an emotion parameter of a user, wherein the emotion parameter represents an emotional status of the user; and an advertisement platform, searching for at least one recommended advertisement classified as the emotional status of the user according to the emotion parameter; and wherein the server-side transceiver further transmits the search result and the at least one recommended advertisement to the client through a network.

### CROSS REFERENCE TO RELATED APPLICATIONS

This application claims the full benefit and priority of Taiwan Patent Application Serial No. 100142880, filed Nov. 23, 2011, and incorporates the entire contents of said application herein.

### BACKGROUND OF THE INVENTION

1. Field of the Invention

The present invention relates to advertising systems, and in particular relates to advertising systems combined with search engine.

2. Description of the Related Art

With widespread network technology and convenient search engine services, advertising systems combined with search engines now link to a market with great potential and profit, includes customers and users of smart phones, portable devices, internet televisions, and personal computers. Prior technology includes displaying ads randomly, selecting and displaying ads based on keywords inputted by a user or based on searching history when operating search functions, or selecting and displaying ads based on geographical location of a user. However, without considering emotional status of a customer, advertisements may cause adverse effects and lower the quality of advertising service. There is still room to improve the cost efficiency and service quality of the conventional advertising systems.

### BRIEF SUMMARY OF THE INVENTION

A detailed description is given in the following embodiments with reference to the accompanying drawings.

An embodiment of the invention shows an advertising system combined with search engine services, comprising a client and a server, wherein the server comprises a server-side transceiver, receiving an emotion signal and a keyword from the client; a search engine, performing search functions according to the keyword and generating a search result; an emotion analyzer, analyzing the emotion signal and generating an emotion parameter of a user, wherein the emotion parameter represents an emotional status of the user; an advertisement platform, searching for at least one recommended advertisement classified as the emotional status of the user according to the emotion parameter; and wherein the server-side transceiver further transmits the search result and the at least one recommended advertisement to the client through a network.

Another embodiment of the invention is a computer executable advertising method combined with search engine services, which is implemented on a server in a network to provide at least one recommended advertisement to a client when executing a searching operation requested by the client, comprising receiving a keyword from the client, and generating at least a search result according to the keyword; receiving emotional characteristics of a user from the client; analyzing the emotional characteristics and generating an emotion parameter, wherein the emotion parameter represents an emotion classification of the user; searching for the at least one recommended advertisement according to the emotion parameter, wherein the at least one recommended advertisement is related to the emotional parameter; and sending the search result and the at least one recommended advertisement to the client through the network.

Another embodiment of the invention is an advertising system combined with search engine services, comprising a client and a server, wherein the client comprises a text input unit, allowing a user to input a keyword; a search engine, performing search functions according to the keyword and generating a search result; an emotion sensor, capturing emotional characteristics of the user, and generating an emotion signal; a client-side transceiver, sending the emotion signal to the server through a network. The server comprises: a server-side transceiver, receiving the emotion signal from the client; an emotion analyzer, analyzing the emotion signal and generating an emotion parameter of a user, wherein the emotion parameter represents the emotional status of the user; and an advertisement platform, searching for at least one recommended advertisement according to the emotion parameter; wherein the server-side transceiver further transmits the at least one recommended advertisement to the client through the network.

Another embodiment of the invention is an advertising system combined with search engine services, comprising a client and a server, wherein the client comprises an audio input unit, allowing a user to input a voice signal; a search engine, performing search functions; a client-side transceiver, sending the voice signal to the server through a network. The server comprises: a server-side transceiver, receiving the voice signal from the client; a voice identifier, identifying the voice signal and generating a keyword; an emotion analyzer, analyzing the voice signal and generating an emotion parameter of the user, wherein the emotion parameter represents an emotional status of the user; and an advertisement platform, searching for at least one recommended advertisement according to the emotion parameter; wherein the server-side transceiver further transmits the keyword and the at least one recommended advertisement to the client through the network, and the search engine performs the search functions according to the keyword and generates a search result.

### BRIEF DESCRIPTION OF THE DRAWINGS

The present invention can be more fully understood by reading the subsequent detailed description and examples with references made to the accompanying drawings, wherein:

FIG. 1 is a block diagram of an advertising system structure according to an embodiment of the invention;

FIG. 2 is an operating block diagram of the advertising system shown in FIG. 1 according to an embodiment of the invention.

FIG. 3 is a block diagram of an advertising system structure according an embodiment of the invention;

FIG. 4 is an operating block diagram of the advertising system shown in FIG. 3 according to an embodiment of the invention.

FIG. 5 is a block diagram of an advertising system structure according to an embodiment of the invention;

FIG. 6 is an operating block diagram of the advertising system shown in FIG. 5 according to an embodiment of the invention.

FIG. 7 is a block diagram of an advertising system structure according to an embodiment of the invention;

FIG. 8 is an operating block diagram of the advertising system shown in FIG. 7 according to an embodiment of the invention.

FIG. 9 is a block diagram of an advertising system structure according to an embodiment of the invention;

FIG. 10 is an operating block diagram of the advertising system shown in FIG. 9 according to an embodiment of the invention.

### DETAILED DESCRIPTION OF THE INVENTION

The advertising systems disclosed in the invention comprise at least one client 100 and a server 200. In some embodiments, the client 100 can be a smart phone, a tablet computer, a personal digital assistant, a laptop computer, a PC, an internet television, and any computer device with network/communication features. The server 200 establishes network connections with the client 100 to provide advertisements and search services. The network 150 can be an internet, a local area network, a wide area network, and a wireless network.

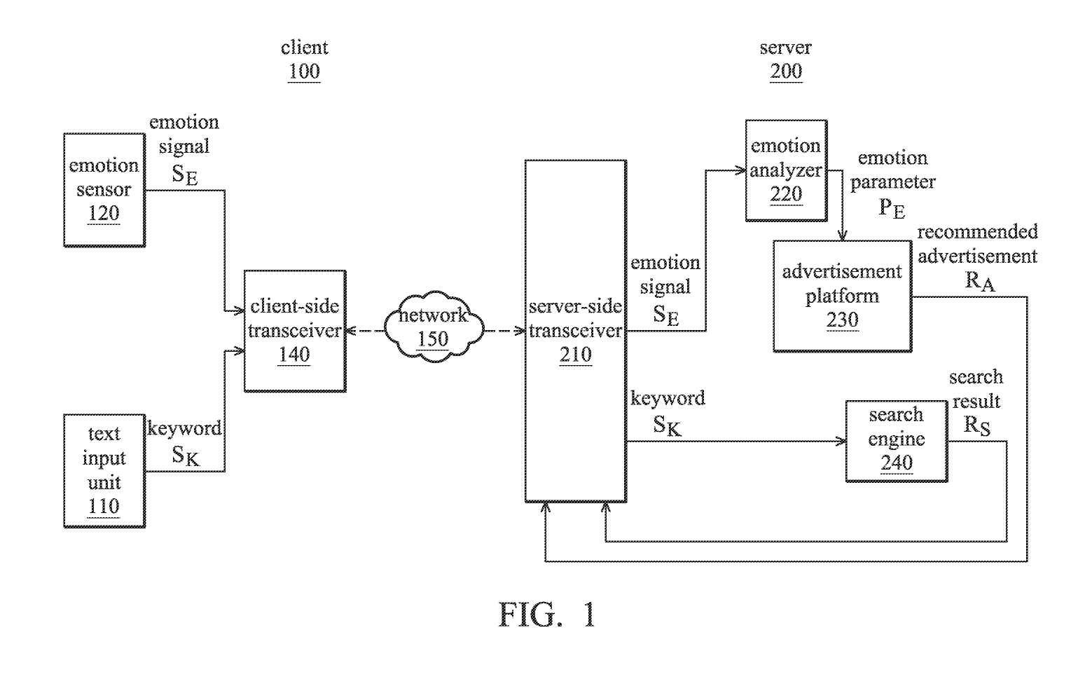

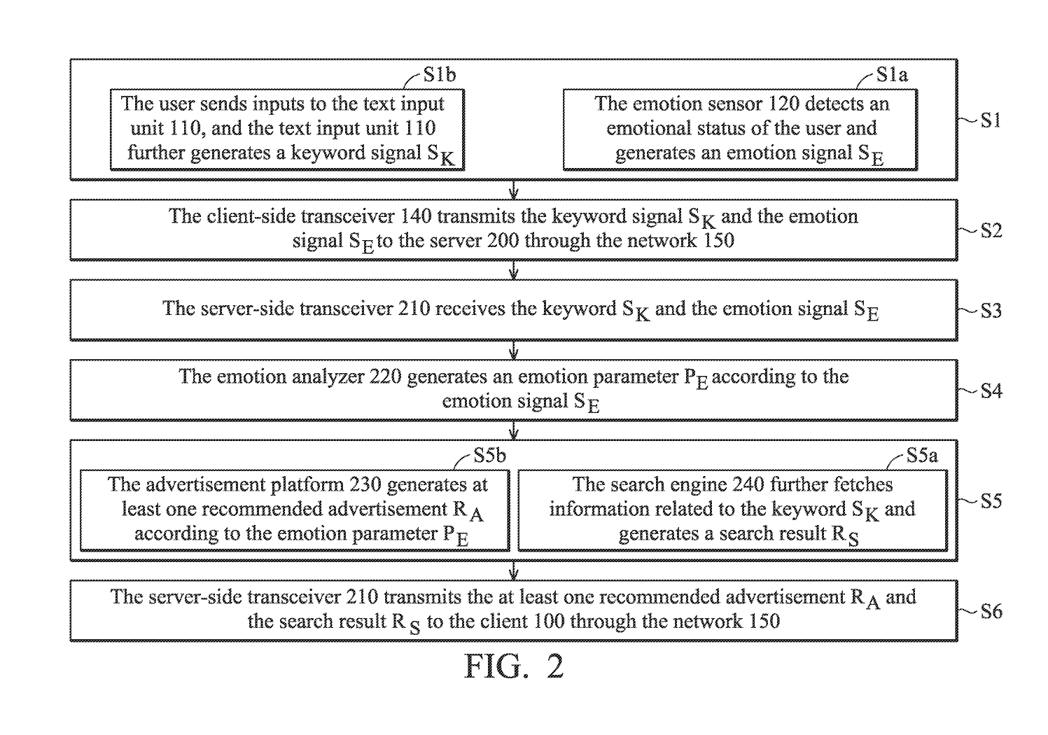

FIG. 1 shows a block diagram of an advertising system structure according to an embodiment of the invention. FIG. 2 shows an operating block diagram of the advertising system shown in FIG. 1. Referring to FIG. 1, the client 100 comprises a text input unit 110, an emotion sensor 120, and a client-side transceiver 140.

As shown in FIG. 2, firstly when a user is accessing the search engine services, the user sends inputs to the text input unit 110, and the text input unit 110 further generates a keyword S_{K} to the client-side transceiver 140 (step S1b). In some embodiments, text input unit 110 may be a keyboard, a mouse, a touch pad, and a microphone. The keyword S_{K} can be a text message, but not limited to it. In the meantime, the emotion sensor 120 senses an emotional status of the user and generates an emotion signal S_{E} to the client-side transceiver 140. In some embodiments, the emotion sensor 120 is a microphone, capturing voice of the user to be used as the emotion signal S_{E}. In some embodiments, the emotion sensor 120 is a camera, capturing static facial expressions of the user to be used as the emotion signal S_{E}. In some embodiments, the emotion sensor 120 is a video camera, capturing dynamic facial expressions of the user to be used as the emotion signal S_{E}. In some embodiments, the emotion sensor 120 is a biosensor, sensing biosignals of the user to be used as the emotion signal S_{E}. In some embodiments, the emotion sensor 120 is a human-machine interface, such as a pen tablet, a mouse, a touch panel, or a keyboard, allowing the user to manually input his/her emotional status and to be used as the emotion signal S_{E}. At step S2, the client-side transceiver 140 further transmits the keyword S_{K} and the emotion signal S_{E} to the server 200 through the network 150.

Referring to FIG. 1, the server 200 comprises a server-side transceiver 210, an emotion analyzer 220, an advertisement platform 230 and a search engine 240. In some embodiments, the emotion analyzer 220 and the search engine 240 are implemented by program codes and commands loaded and executed by at least a processor. As shown in FIG. 2, server-side transceiver 210 further receives the keyword S_{K} and the emotion signal S_{E} (step S3), wherein the emotion signal S_{E} is inputted into the emotion analyzer 220. The emotion analyzer 220 proceeds to verify emotion characteristics of the user according to the emotion signal S_{E}. In some embodiments, the emotion signal S_{E} is a voice data inputted by the user, and the emotion analyzer 220 analyzes tone features of the emotion signal S_{E} to verify an emotional status of the user. In some embodiments, the emotion signal S_{E} is a static/dynamic facial expression of the user captured by a camera, and the emotion analyzer 220 analyzes expression characteristics of the emotion signal S_{E} to verify emotional status of the user. In some embodiments, the emotion signal S_{E} is a biosignal of the user, such as blood pressure, heart rate, body temperature or biocurrent, and the emotion analyzer 220 analyzes biological characteristics of the emotion signal S_{E} to verify an emotional status of the user. In some embodiments, the emotion signal S_{E} is manually inputted by the user through a human-machine interface, and the emotion analyzer 220 decides an emotional status of the user according to the emotion signal S_{E}. The emotion analyzer 220 proceeds to generate an emotion parameter P_{E} based on the analyzing results (Step S4). The emotion parameter P_{E} represents a classification of an emotion of the user, for example, happy, angry, upset, or depressed.

At step S5, the keyword S_{K} is inputted into the search engine 240, and the search engine 240 further fetches information related to the keyword S_{K} from an information database (not shown). The information can be webpages, geographic locations, or data files. The search engine 240 then generates a search result R_{S} (step S5a). The emotion parameter P_{E} otherwise be sent to the advertisement platform 230. The advertisement platform 230 comprises an advertisement database (not shown) and a search unit (not shown). The advertisement database stores a plurality of ads, wherein each of the ads is classified according to a predetermined emotion parameter. The search unit fetches a part of the ads from the advertisement database to be at least one recommended advertisement R_{A}, wherein the predetermined emotion parameter of the at least one recommended advertisement R_{A} matches the emotion parameter P_{E} (step S5b). For example, when the emotion parameter P_{E} indicates that the user is impatient, the search unit fetches a part of the ads classified for impatient customers, like herbal tea promo or yoga lecture discount, to be the at least one recommended advertisement R_{A}. At step S6, the server-side transceiver 210 transmits the at least one recommended advertisement R_{A} and the search result R_{S} to the client 100 through the network 150. In some embodiments, the client 100 further comprises a display unit and/or an audio amplifier, showing and/or playing the at least one recommended advertisement R_{A}.

In some other embodiments, both of the emotion parameter P_{E} and the keyword S_{K} are transmitted to the advertisement platform 230. The advertisement platform 230 comprises an advertisement database (not shown) and a search unit (not shown). The advertisement database stores a plurality of ads, wherein each of the ads is classified according to a predetermined emotion parameter. The search unit fetches a part of the ads from the advertisement database to be at least one recommended advertisement R_{A}, wherein the predetermined emotion parameter of the at least one recommended advertisement R_{A} not only matches the emotion parameter P_{E}, but is also related to the keyword S_{K}.

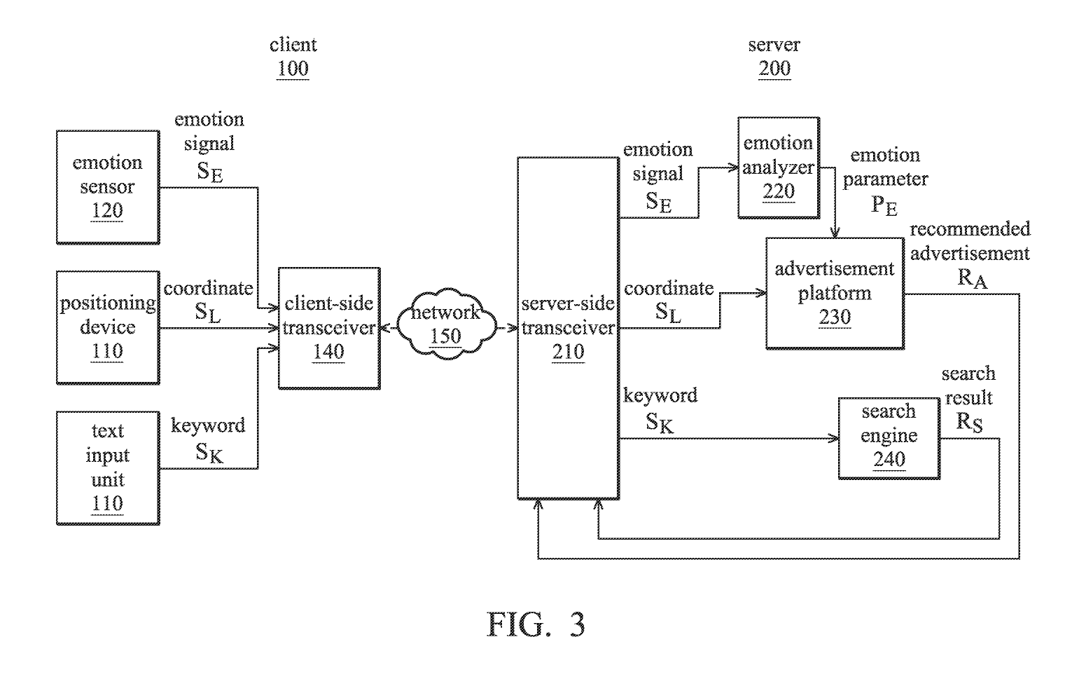

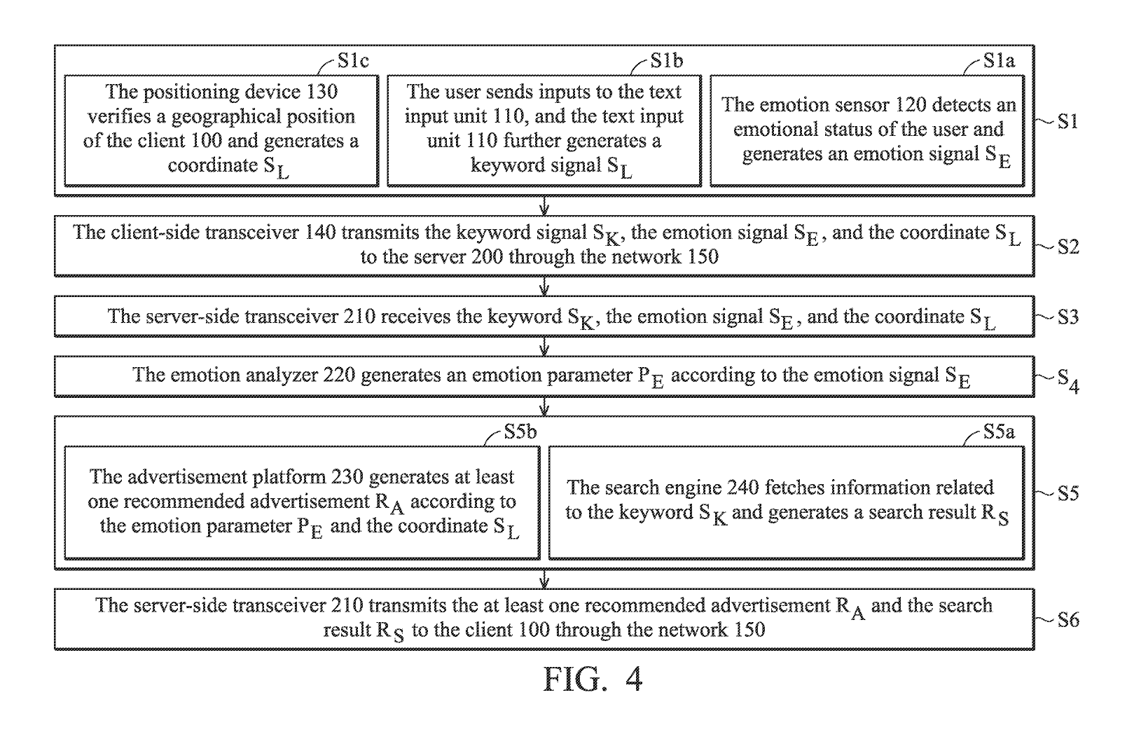

FIG. 3 is a block diagram of an advertising system structure according to another embodiment of the invention. FIG. 4 is an operating block diagram of the advertising system shown in FIG. 3. The advertising systems in FIG. 3 are similar to the embodiment in FIG. 1 except that the client 100 of the advertising systems in FIG. 3 further comprises a positioning device 130, verifying a geographical position of the client 100 and generating a coordinate S_{L} when the user is requesting for search engine services (step S1c). In some embodiments, the positioning device 130 generates the coordinate S_{L} via a Global Positioning System, trilateration, and any other method that is capable of acquiring the geographical position of the client 100. Steps S1a and S1b are substantially the same as the embodiment in FIG. 2, and the details will not be repeatedly addressed. The client-side transceiver 140 sends the keyword S_{K}, the emotion signal S_{E}, and the coordinate S_{L} to the server 200 through the network 150 (step S2).

Now referring to FIG. 3, the server 200 comprises a server-side transceiver 210, an emotion analyzer 220, an advertisement 230 and a search engine 240. Referring to FIG. 4, the server-side transceiver 210 receives the keyword S_{K}, the emotion signal S_{E}, and the coordinate S_{L} from the client 100 (step S3), wherein the emotion signal S_{E} is inputted to the emotion analyzer 220, and the emotion analyzer 220 proceeds to verify emotion characteristics of the user according to the emotion signal S_{E} and generates an emotion parameter P_{E} based on the analyzing results (Step S4).

At step S5, the keyword S_{K} is inputted to the search engine 240, and the search engine 240 further fetches information related to the keyword S_{K} from an information database (not shown) and generates a search result R_{S} (step S5a). The emotion parameter P_{E} is sent to the advertisement platform 230. The advertisement platform 230 comprises an advertisement database (not shown) and a search unit (not shown). The advertisement database stores a plurality of ads, wherein each of the ads is not only classified according to a predetermined emotion parameter, but also comprises a predetermined coordinate, representing the advertised location. The search unit fetches a part of the ads from the advertisement database to be at least one recommended advertisement R_{A}, wherein the predetermined emotion parameter of the at least one recommended advertisement R_{A} matches the emotion parameter P_{E} of the user and is also close to the geographical position of the user (step S5b). At step S6, the server-side transceiver 210 transmits the at least one recommended advertisement R_{A} and the search result R_{S} to the client 100 through the network 150. For example, when the user accesses the search engine service and his/her emotional status is verified as being angry, the advertisement platform 230 provides at least a recommended advertisement classified as for angry customers, for example free gym trials, or opening promo for a coffee shop, and the gym and the coffee shop are located approximately 200 meters away from the user. In some embodiments, the client 100 further comprises a display unit and/or an audio amplifier, showing and/or playing the at least one recommended advertisement R_{A}.

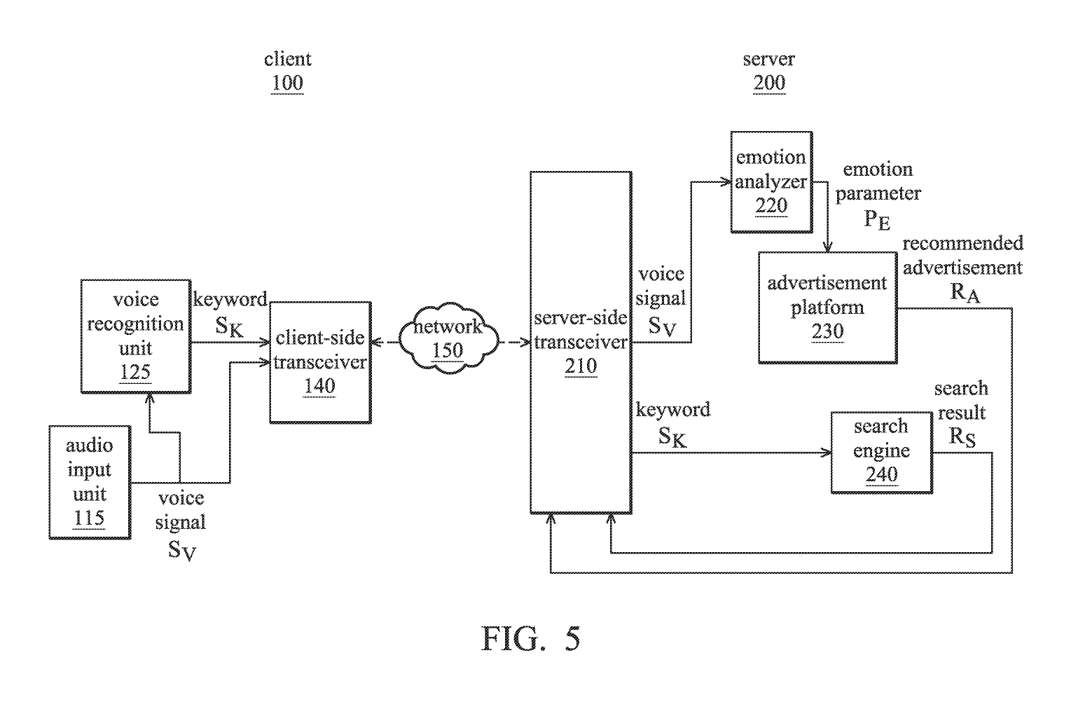

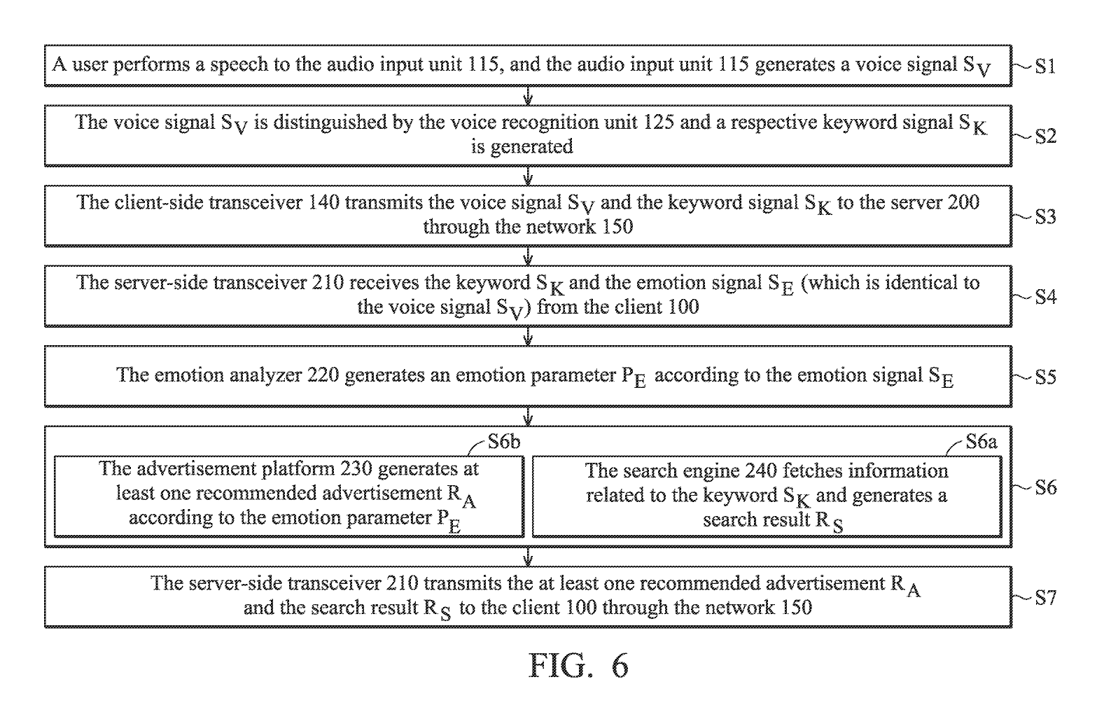

FIG. 5 is a block diagram of an advertising system structure according to another embodiment of the invention. FIG. 6 is an operating block diagram of the advertising system shown in FIG. 5. As shown in FIG. 5, the client 100 comprises an audio input unit 115, a voice recognition unit 125 and a client-side transceiver 140.

Referring to step S1 in FIG. 6, when accessing the search engine services, a user performs a speech to the audio input unit 115 to input keywords to be searched, and the audio input unit 115 generates a voice signal S_{V}. The voice signal S_{V} further distinguished by the voice recognition unit 125 and a respective keyword S_{K} is generated (step S2). The client-side transceiver 140 proceeds to transmit the voice signal S_{V} and the keyword S_{K} to the server 200 through the network 150 (step S3). For example, the user who wants to search information about Japanese food says “Japanese food” to the audio input unit 115, for example a microphone; and the microphone records the voice of the user as a voice signal S_{V}. The voice signal S_{V} is then verified by the voice recognition unit 125 and translated to the keyword S_{K}, for example the character codes “Japanese food”. The voice signal S_{V} also contains emotional information of the user, such as the tone of the voice. Therefore, both of the keyword S_{K} and the voice signal S_{V} are provided to the server 200.

Further referring to FIG. 5, the server 200 is substantially similar to the embodiment in FIG. 1 except that the emotion analyzer 220 of the server 200 regards the voice signal S_{V} as the emotional signal S_{E}. The server-side transceiver 210 further receives the keyword S_{K} and the voice signal S_{V} from the client 100(step S4), wherein the voice signal S_{V} is inputted into the emotion analyzer 220, and the emotion analyzer 220 proceeds to verify emotion characteristics of the user according to the voice signal S_{V} (step S5).

At step S6, the keyword S_{K} is inputted to the search engine 240, and the search engine 240 further fetches information related to the keyword S_{K} from an information database (not shown) and generates a search result R_{S} (step S6a); The emotion parameter P_{E} is sent to the advertisement platform 230. The advertisement platform 230 comprises an advertisement database (not shown) and a search unit (not shown). The advertisement database stores a plurality of ads, wherein each of the ads is classified according to a predetermined emotion parameter. The search unit fetches part of the ads from the advertisement database to be at least one recommended advertisement R_{A} (step S6b), wherein the predetermined emotion parameter of the at least one recommended advertisement R_{A} matches the emotion parameter P_{E} of the user. For example, when the user is doing a search via the voice input, and the emotion parameter P_{E} indicates that the user is happy, the search unit fetches a part of the ads classified as for happy customers, like department store anniversary promo or 3C mall discount, to be the at least one recommended advertisement R_{A}.

At step S7, the server-side transceiver 210 transmits the at least one recommended advertisement R_{A} and the search result R_{S} to the client 100 through the network 150. In some embodiments, the client 100 further comprises a display unit and/or an audio amplifier, showing and/or playing the at least one recommended advertisement R_{A}.

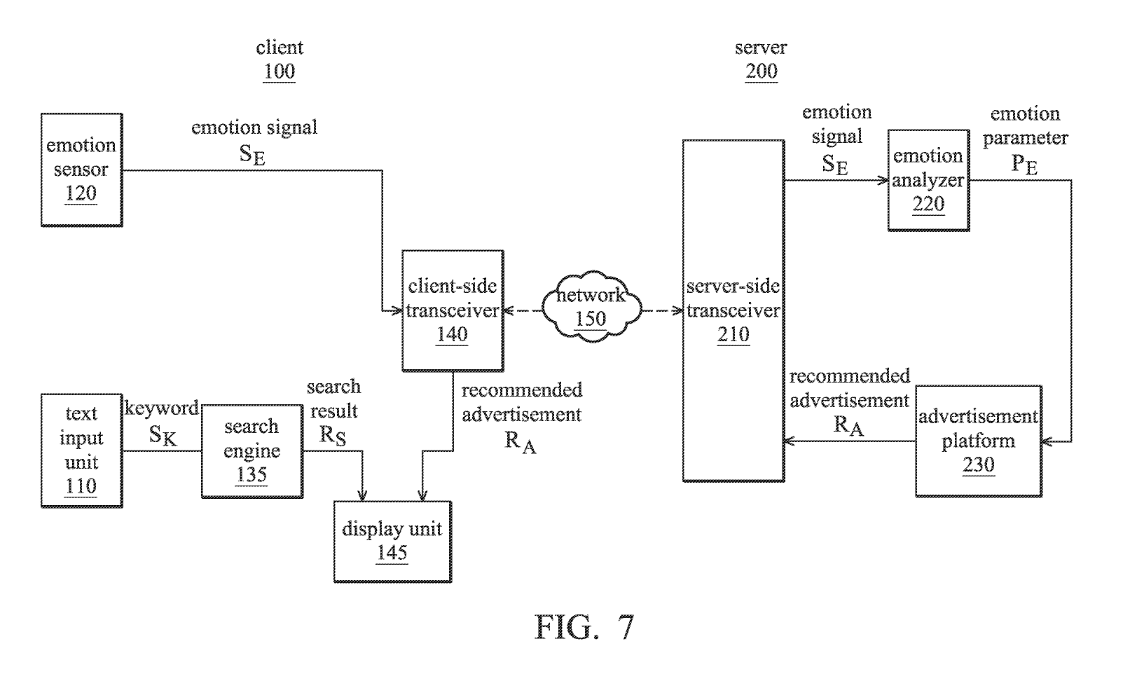

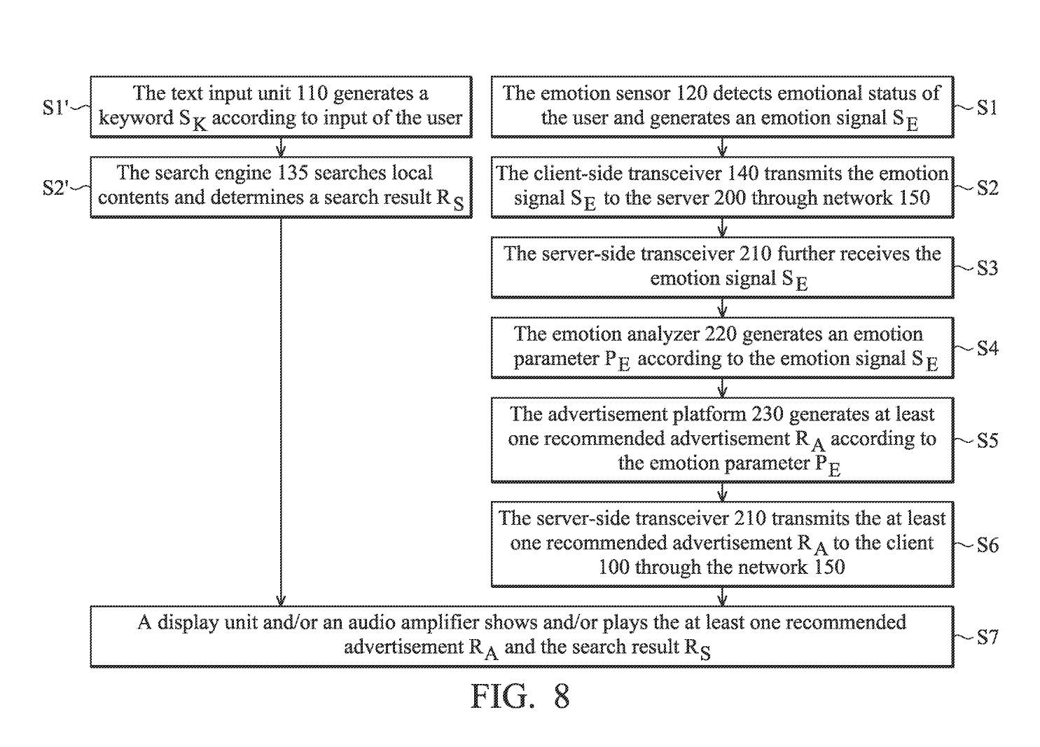

FIG. 7 is a block diagram of an advertising system structure according to another embodiment of the invention. FIG. 8 is an operating block diagram of the advertising system shown in FIG. 7. The advertising system in FIG. 7 is similar to the embodiment in FIG. 1, except that the search engine function is not implemented at the server side, but at the client side. The client 100 of the advertising system in FIG. 7 further comprises a search engine 135. Details of similar structures and functions will not be repeatedly addressed.

When a user inputs keywords to perform a search function, text input unit 110 of the client 100 generates a keyword S_{K} (step S1′), and the search engine 135 searches the local contents including functions and data, and determines a search result R_{S} (step S2′). The search engine 135 may be a search program executed by a processor of the client 100, for example a search function of a smart TV, which allows the user to search for contents among channel lists and show the lists. The search engine 135 further displays the search result R_{S} on a display unit 145.

In the meantime, the emotion sensor 120 detects the emotional status of the user and generates an emotion signal S_{E} to the client-side transceiver 140 (step S1). At step S2, the client-side transceiver 140 transmits the emotion signal S_{E} to the server 200 through network 150.

Now referring to FIG. 7, the server 200 comprises a server-side transceiver 210, an emotion analyzer 220, and an advertisement platform 230. In some embodiment, the emotion analyzer 220 is a program loaded and executed by at least a processor. As shown in FIG. 8, the server-side transceiver 210 further receives the emotion signal S_{E} (step S3), wherein the emotion signal S_{E} is inputted into the emotion analyzer 220. The emotion analyzer 220 proceeds to verify emotion characteristics of the user according to the emotion signal S_{E} and generates an emotion parameter P_{E} (step S4). The emotion parameter P_{E} represents a classification of an emotion of the user, for example, happy, angry, upset, or depressed.

The emotion parameter P_{E} is sent to the advertisement platform 230. The advertisement platform 230 comprises an advertisement database (not shown), and a search unit (not shown). The advertisement database stores a plurality of ads, wherein each of the ads is classified according to a predetermined emotion parameter. The search unit fetches a part of the ads from the advertisement database to be at least one recommended advertisement R_{A}, wherein the predetermined emotion parameter of the at least one recommended advertisement R_{A} matches the emotion parameter P_{E} of the user (step S5).

At step S6, the server-side transceiver 210 transmits the at least one recommended advertisement R_{A} and the search result R_{S} to the client 100 through the network 150. In some embodiments, the client 100 further comprises a display unit and/or an audio amplifier, showing and/or playing the at least one recommended advertisement R_{A} (step S7).

In some other embodiments, the client-side transceiver 140 also transmits the keyword S_{K} to the server 200 through network 150. The emotion parameter P_{E} and the keyword S_{K} are sent to the advertisement platform 230. The advertisement platform 230 comprises an advertisement database and a search unit. The advertisement database stores a plurality of ads, wherein each of the ads is classified according to a predetermined emotion parameter. The search unit fetches a part of the ads from the advertisement database to be at least one recommended advertisement R_{A}, wherein the predetermined emotion parameter of the at least one recommended advertisement R_{A} not only matches the emotion parameter P_{E} of the user but is also related to the keyword S_{K}.

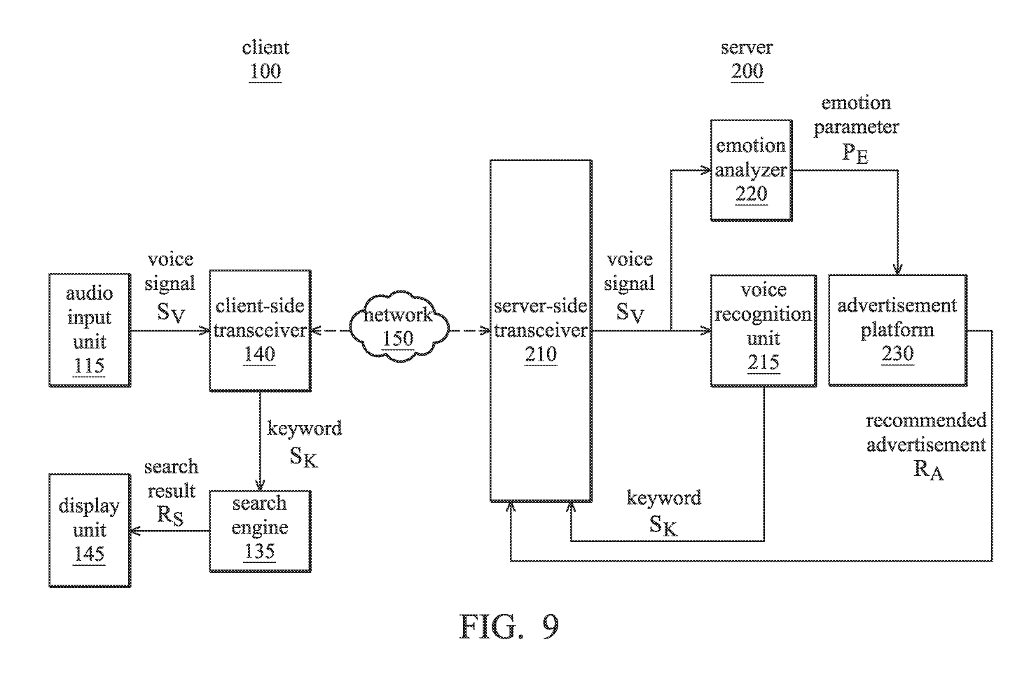

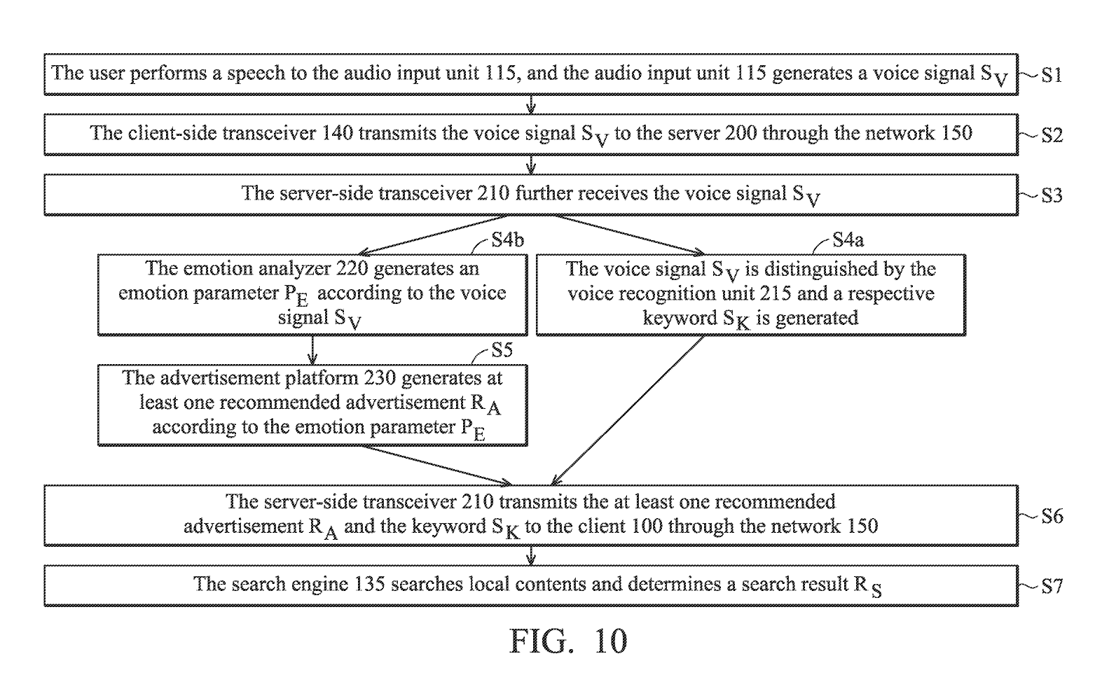

FIG. 9 is a block diagram of an advertising system structure according to another embodiment of the invention. FIG. 10 is an operating block diagram of the advertising system shown in FIG. 9. The client 100 in the embodiment of FIG. 9 is a portable device with voice recognition function on the server side, verifying voice input of the user and transferring the verification result back the client. The client searches local functions or data, such as to do lists, data stored in memory cards, or a phone number directory, according to the verification result.

Referring to FIG. 9, the client 100 comprises an audio input unit 115 and a client-side transceiver 140. As shown in step S1 of FIG. 10, when a user accesses the search engine services, the user performs a speech to the audio input unit 115 to input keywords to be searched, and the audio input unit 115 generates a voice signal S_{V}. The voice signal S_{V} may be a voice command, including words or complete sentences, such as “phone number directory” or “open calendar to February of next year”. The client-side transceiver 140 proceeds to transmit the voice signal S_{V} to the server 200 through the network 150 (step S2). The server-side transceiver 210 of the server 200 receives the voice signal S_{V} (step S3), and the voice signal S_{V} is inputted into a voice recognition unit 215. The voice recognition unit 215 distinguishes the voice signal S_{V} and generates a keyword S_{K}. (step S4a). The voice signal S_{V} is also inputted into the emotion analyzer 220. The emotion analyzer 220 proceeds to verify emotion characteristics of the user according to the voice signal S_{V} and generates an emotion parameter P_{E} (step S4b).

At step S5, the emotion parameter P_{E} is sent to the advertisement platform 230. The advertisement platform 230 comprises an advertisement database (not shown) and a search unit (not shown). The advertisement database stores a plurality of ads, wherein each of the ads is classified according to a predetermined emotion parameter. The search unit fetches a part of the ads from the advertisement database to be at least one recommended advertisement R_{A}, wherein the predetermined emotion parameter of the at least one recommended advertisement R_{A} matches the emotion parameter P_{E} of the user. Continue to step S6, the server-side transceiver 210 transmits the at least one recommended advertisement R_{A} and the keyword S_{K} to the client 100 through the network 150 (step S6). The client 100 further comprises a local search engine 135, searches functions and data according to the keyword S_{K} and generates a search result R_{S}. In some embodiments, the client 100 further comprises a display unit 145 and/or an audio amplifier (not shown), showing and/or playing the search result R_{S} the at least one recommended advertisement R_{A}.

The embodiments and examples disclosed above are advertisement systems combined with a search engine, providing advertisements which are more precisely chosen and suitable for customers with different moods. The advertisement systems in the invention increase cost efficiency of the ads, strengthen connections between vendors and the customers, and improve service quality by providing more customizable option.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An advertising system combined with search engine services, comprising a client and a server, wherein the server comprises:
a server-side transceiver, receiving an emotion signal and a keyword from the client;
a search engine, performing search functions according to the keyword and generating a search result;
an emotion analyzer, analyzing the emotion signal and generating an emotion parameter of a user, wherein the emotion parameter represents an emotional status of the user; and
an advertisement platform, searching for at least one recommended advertisement classified as the emotional status of the user according to the emotion parameter;
wherein the server-side transceiver further transmits the search result and the at least one recommended advertisement to the client through a network.

2. The advertising system of claim 1, wherein the client further comprises:
a text input unit, allowing the user to input the keyword;
an emotion sensor, capturing emotional characteristics of the user, and generating the emotion signal; and
a client-side transceiver, sending the keyword and the emotion signal to the server through the network.

3. The advertising system of claim 1, wherein the client further comprises:
an audio input unit, allowing the user to input a voice signal and verifying the voice signal to generate the keyword, wherein the voice signal is regarded as the emotion signal; and
a client-side transceiver, sending the keyword and the emotion signal to the server through the network.

4. The advertising system of claim 2, wherein the emotion sensor can be one of the following devices: a microphone, a camera, a video camera, a biosensor, and a human-machine interface.

5. The advertising system of claim 1, wherein the client further comprises a positioning device, verifying a geographical position of the user and generating a coordinate, wherein the client-side transceiver sends the coordinate to the server through the network, and the advertisement platform determines the at least one recommended advertisement according to the emotion parameter and the coordinate, wherein the at least one recommended advertisement matches the emotional status of the user and advertised locations of the at least one recommended advertisement are close to the geographical position of the user.

6. The advertising system of claim 5, wherein the positioning device generating the coordinate via a Global Positioning System, trilateration, and any other method that is capable of acquiring the coordinate.

7. The advertising system of claim 1, wherein the advertisement platform further comprises:
an advertisement database, storing a plurality of ads, wherein each of the ads is classified according to a predetermined emotion parameter; and
a searching unit, fetching a part of the ads from the advertisement database to be the at least one recommended advertisement, wherein the predetermined emotion parameter of the at least one recommended advertisement matches the emotion parameter of the user.

8. The advertising system of claim 1, wherein the advertisement platform further comprises:
an advertisement database, storing a plurality of ads, wherein each of the ads is classified according to a predetermined emotion parameter; and
a searching unit, fetching a part of the ads from the advertisement database to be the at least one recommended advertisement, wherein the predetermined emotion parameter of the at least one recommended advertisement matches the emotion parameter of the user and are related to the keyword.

9. The advertising system of claim 2 or 3, wherein the client further comprises a display unit, displaying the search result and the at least one recommended advertisement.

10. The advertising system of claim 1, wherein the emotion analyzer and the search engine are programs loaded and executed by at least a processor.

11. A computer executable advertising method combined with search engine services, which is implemented on a server in a network to provide at least one recommended advertisement to a client when executing a searching operation requested by the client, comprising:
receiving a keyword from the client, and generating at least a search result according to the keyword;
receiving emotional characteristics of a user from the client;
analyzing the emotional characteristics and generating an emotion parameter, wherein the emotion parameter represents an emotion classification of the user;
searching for the at least one recommended advertisement according to the emotion parameter, wherein the at least one recommended advertisement is related to the emotional parameter; and
sending the search result and the at least one recommended advertisement to the client through the network.

12. The computer executable advertising method of claim 11, wherein the emotional characteristics include voice signals, facial expressions, biosignals, or information inputted by the user.

13. The computer executable advertising method of claim 11, further comprises receiving a location coordinate from the client, and providing the at least one recommended advertisement according to the emotional parameter and the location coordinate, wherein the at least one recommended advertisement corresponds to the emotional parameter and is close to the location coordinate.

14. The computer executable advertising method of claim 11, wherein the at least one recommended advertisement is further related to the keyword.

15. The computer executable advertising method of claim 11, wherein the at least one recommended advertisement is fetched from an advertisement database and comprises a predetermined emotion parameter, wherein the predetermined emotion parameter matches the emotion parameter of the user.

16. An advertising system combined with search engine services, comprising a client and a server, wherein:
the client comprises:
a text input unit, allowing a user to input a keyword;
a search engine, performing search functions according to the keyword and generating a search result;
an emotion sensor, capturing emotional characteristics of the user, and generating an emotion signal;
a client-side transceiver, sending the emotion signal to the server through a network; and
the server comprises:
a server-side transceiver, receiving the emotion signal from the client;
an emotion analyzer, analyzing the emotion signal and generating an emotion parameter of a user, wherein the emotion parameter represents the emotional status of the user; and
an advertisement platform, searching for at least one recommended advertisement according to the emotion parameter;
wherein the server-side transceiver further transmits the at least one recommended advertisement to the client through the network.

17. The advertising system of claim 16, wherein the emotion sensor can be one of the following devices: a microphone, a camera, a video camera, a biosensor, and a human-machine interface.

18. The advertising system of claim 16, wherein the advertisement platform further comprises:
an advertisement database, storing a plurality of ads, wherein each of the ads is classified according to a predetermined emotion parameter; and
a searching unit, fetching a part of the ads from the advertisement database to be the at least one recommended advertisement, wherein the predetermined emotion parameter of the at least one recommended advertisement matches the emotion parameter of the user.

19. The advertising system of claim 16, wherein the client further comprises a display unit, displaying the search result and the at lest one recommended advertisement.

20. An advertising system combined with search engine services, comprising a client and a server, wherein:
the client comprises:
an audio input unit, allowing a user to input a voice signal;
a search engine, performing search functions;
a client-side transceiver, sending the voice signal to the server through a network; and
the server comprises:
a server-side transceiver, receiving the voice signal from the client;
a voice identifier, identifying the voice signal and generating a keyword;
an emotion analyzer, analyzing the voice signal and generating an emotion parameter of the user, wherein the emotion parameter represents an emotional status of the user; and
an advertisement platform, searching for at least one recommended advertisement according to the emotion parameter,
wherein the server-side transceiver further transmits the keyword and the at least one recommended advertisement to the client through the network, and the search engine performs the search functions according to the keyword and generates a search result.

21. The advertising system of claim 20, wherein the advertisement platform further comprises:
an advertisement database, storing a plurality of ads, wherein each of the ads is classified according to a predetermined emotion parameter; and
a searching unit, fetching a part of the ads from the advertisement database to be the at least one recommended advertisement, wherein the predetermined emotion parameter of the at least one recommended advertisement matches the emotion parameter of the user.

22. The advertising system of claim 20, wherein the client further comprises a display unit, displaying the search result and the recommended advertisement.
